(19) United States
(12) Patent Application Publication
(10) Pub. No.: US 2018/0266817 A1
(43) Pub. Date: Sep. 20, 2018

(54) PROFILE MEASURING MACHINE

(71) Applicant: MITUTOYO CORPORATION, Kanagawa (JP)

(72) Inventors: Shoji KASHIWABUCHI, Tochigi (JP); Kazuaki KAWARAI, Tochigi (JP)

(73) Assignee: MITUTOYO CORPORATION, Kanagawa (JP)

(21) Appl. No.: 15/916,688

(22) Filed: Mar. 9, 2018

(30) Foreign Application Priority Data
Mar. 16, 2017 (JP) 2017-050989

(51) Int. Cl. G01B 21/20; G01B 5/00

(52) U.S. Cl. CPC G01B 21/20; G01B 5/0014

(57) ABSTRACT

A profile measuring machine includes: a first column and a second column forming a portal structure of a movement mechanism supporting a probe; a first guide made of a first material and configured to guide the first column; a second guide provided in parallel to the first guide, made of a second material different from the first material, and configured to guide the second column; a first support supporting the first guide on a foundation; a second support supporting the second guide on the foundation; and a thermal expansion compensator configured to compensate a difference in thermal expansion between the first guide and the second guide.

The entire disclosure of Japanese Patent Application No. 2017-050989 filed Mar. 16, 2017 is expressly incorporated by reference herein.

### TECHNICAL FIELD

The present invention relates to a profile measuring machine.

### BACKGROUND ART

In order to measure a profile, dimensions, a surface position and the like of a measurement target (workpiece), a profile measuring machine such as a coordinates measuring machine and a three-dimensional measuring machine is used.

The profile measuring machine uses a three-dimensional movement mechanism configured to move a contact or non-contact probe in three dimensions in order to bring the probe into contact with or close to a measurement portion of the workpiece.

The three-dimensional movement mechanism has, for instance, a portal structure including a pair of columns and a crossbar such that the portal structure straddles a table (platform) on which the workpiece is placed. A spindle is provided to the crossbar via a saddle. The probe is attached to a lower end of the spindle.

The portal structure is movable along edges of the table by an X-axis movement mechanism. The saddle is movable along the crossbar by a Y-axis movement mechanism. The spindle is movable upward and downward in a Z-axis direction with respect to the saddle by a Z-axis movement mechanism.

The three-dimensional movement mechanism with this structure allows the probe to be brought close to any portion of the workpiece on the table.

The X-axis movement mechanism of the three-dimensional movement mechanism uses a part of the table as a guide. Specifically, lateral surfaces extending along an X axis, a region on an upper surface along the lateral surfaces in an X-axis direction, or a surface of a groove or a projection in the X-axis direction is usable as the guide. An air pad or an air bearing is provided to each of the columns in a manner to face a part of the table (i.e., the guide), so that the columns are smoothly slidable on the surface of the guide (see Patent Literature 1: JP2012-042267A).

The table of the profile measuring machine is in a form of a continuous surface plate made of stone (mainly gabbro) The stone-made table advantageously has a high hardness and a non-magnetic property. Further, the surface of the stone-made table used as the guide is precisely polished to provide a high smoothness, whereby an air film between the surface and the air pad can be extremely thinned and the columns can smoothly move at a high accuracy.

There is a demand for measuring a large workpiece and enlarging the profile measuring machine described above. Enlarging the profile measuring machine requires enlarging the aforementioned three-dimensional movement mechanism.

However, since a table of a typical profile measuring machine is made of stone, manufacturing of an elongated table entails an increase in costs and a manufacturing period. Further, it is also difficult to obtain a stone capable of being cut out into an elongated table and to transport the elongated table.

On the other hand, it is conceivable to make a metallic table. When a metallic material is used, the material is easily formable and it is also easy to provide an elongated table by jointing a plurality of metallic pieces.

However, in order to manufacture the metallic table, it is indispensable to joint the plurality of pieces at a high accuracy and to smooth a surface, including a welded mark of the joint, of the table. Moreover, even if the surface of the metallic table is made highly smooth, the metallic table is likely to have rust and a scratch to deteriorate smoothness. Particularly, when rust and a scratch are generated at a part of the table facing the air pad of each of the columns, the surface of the table cannot stably function as the guide.

### SUMMARY OF THE INVENTION

An object of the invention is to provide a profile measuring machine capable of restraining an increase in costs and a manufacturing period even when the profile measuring machine is enlarged, and capable of providing a stable guide function.

According to an aspect of the invention, a profile measuring machine includes: a first column and a second column forming a portal structure of a movement mechanism supporting a probe; a first guide made of a first material and configured to guide the first column; a second guide provided in parallel to the first guide, made of a second material different from the first material, and configured to guide the second column; a first support supporting the first guide; a second support supporting the second guide; and a thermal expansion compensator provided to at least one of the first guide, the second guide, the first support or the second support, and configured to compensate a difference in thermal expansion between the first guide and the second guide.

In the above aspect of the invention, the first support and the second support respectively support the first guide and the second guide on a foundation. The first column and the second column of the movement mechanism are respectively guided by the first guide and the second guide, whereby the movement mechanism and the probe are movable in a longitudinal direction of the first guide and the second guide.

The first guide and the second guide are respectively formed of a first material and a second material. Accordingly, when an air temperature changes, the first guide and the second guide differently change in a support height, a length and the like depending on a difference in a thermal expansion coefficient between the first material and the second material.

However, in the above aspect of the invention, the thermal expansion compensator can compensate the difference in thermal expansion between the first guide and the second guide.

In the above aspect of the invention, for instance, the first material and the second material can be stone and metal, respectively. In other words, since one of the materials for the first guide and the second guide is not stone, even when the profile measuring machine is enlarged, an increase in the costs and the manufacturing period can be restrained. Moreover, since rust and a scratch are not generated on the stone-made second guide to avoid deterioration in smoothness, the second guide can stably function as a guide.

In the above arrangement, it is preferable that the profile measuring machine further includes at least one temperature sensor configured to detect a temperature of at least one of the first guide or the second guide, in which the thermal expansion compensator is configured to compensate the difference in thermal expansion between the first guide and the second guide with reference to the temperature detected by the at least one temperature sensor.

With this arrangement, the difference in thermal expansion between the first guide and the second guide can be compensated based on actual temperatures of the respective first guide and second guide, thereby allowing an appropriate compensation when the first material and the second material are different.

In the profile measuring machine in the above aspect of the invention, it is preferable that the thermal expansion compensator includes at least one height adjustment mechanism provided to at least one of the first support or the second support.

With this arrangement, when the support heights of the first guide and the second guide change depending on a temperature, the height adjustment mechanism can compensate the height of the first support and the height of the second support.

In the profile measuring machine in the above aspect of the invention, it is preferable that the thermal expansion compensator includes a temperature adjuster configured to heat and/or cool the first guide and the second guide.

With this arrangement, when the support heights and the lengths of the first guide and the second guide change depending on a temperature, the temperature adjustment mechanism can cancel the temperature change and thermal expansion of the first guide and the second guide.

According to another aspect of the invention, a profile measuring machine includes: a movement mechanism having a portal structure formed by a first column and a second column; a probe supported by the movement mechanism; a first guide made of a first material and configured to guide the first column; a second guide provided in parallel to the first guide, made of a second material different from the first material, and configured to guide the second column; and a calculator configured to control the movement mechanism and calculate a measurement value based on a signal from the probe, the calculator including a measurement value corrector configured to correct the measurement value based on a difference in thermal expansion between the first guide and the second guide.

In the above aspect of the invention, a first support and a second support respectively support the first guide and the second guide on a foundation. The first column and the second column of the movement mechanism are respectively guided by the first guide and the second guide, whereby the movement mechanism and the probe are movable in a longitudinal direction of the first guide and the second guide.

The first guide and the second guide are respectively formed of a first material and a second material. Accordingly, when an air temperature changes, the first guide and the second guide differently change in a support height, a length and the like depending on a difference in a thermal expansion coefficient between the first material and the second material. This change sometimes causes an error on the measurement value calculated by the calculator.

However, in the above aspect of the invention, the measurement value corrector can correct the measurement value calculated by the calculator depending on a temperature.

In the above aspect of the invention, for instance, the first material and the second material can be stone and metal, respectively. In other words, since one of the materials for the first guide and the second guide is not stone, even when the profile measuring machine is enlarged, an increase in the costs and the manufacturing period can be restrained. Moreover, since rust and a scratch are not generated on the stone-made second guide to avoid deterioration in smoothness, the second guide can stably function as a guide.

In the above arrangement, it is preferable that the profile measuring machine further includes at least one temperature sensor configured to detect a temperature of at least one of the first guide or the second guide, in which the measurement value corrector is configured to correct the measurement value with reference to the temperature detected by the at least one temperature sensor.

With this arrangement, the measurement value calculated by the calculator can be corrected based on actual temperatures of the respective first guide and second guide, whereby an appropriate measurement value is obtainable even when the first material and the second material are different.

In the profile measuring machine in the above aspect of the invention, it is preferable that the first material is stone and the second material is metal.

With this arrangement, since stone and metal are respectively used for the first guide and the second guide, the profile measuring machine can restrain an increase in the costs and the manufacturing period even when being enlarged, and can provide a stable guide function.

According to the above aspects of the invention, the profile measuring machine capable of restraining an increase in costs and a manufacturing period even when the profile measuring machine is enlarged, and capable of providing a stable guide function can be provided.

### BRIEF DESCRIPTION OF DRAWING(S)

FIG. 1 is a perspective view showing a profile measuring machine according to a first exemplary embodiment of the invention.

FIG. 2 is a perspective view showing a profile measuring machine according to a second exemplary embodiment of the invention.

FIG. 3 is a perspective view showing a profile measuring machine according to a third exemplary embodiment of the invention.

### DESCRIPTION OF EMBODIMENT(S)

### First Exemplary Embodiment

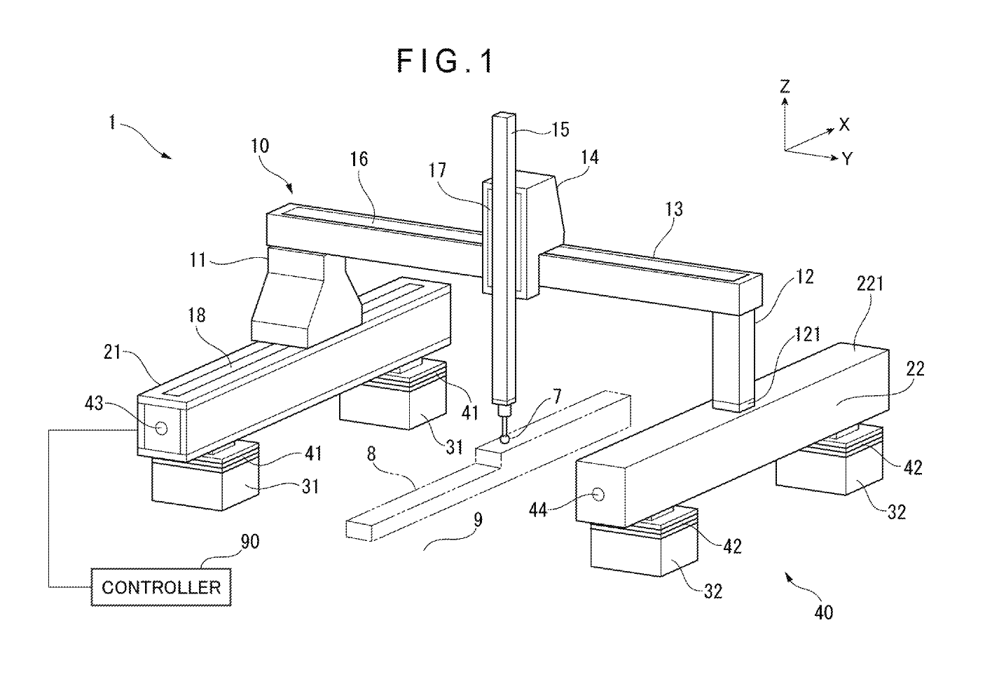

FIG. 1 shows a profile measuring machine 1 according to a first exemplary embodiment of the invention.

The profile measuring machine 1 is set on a stable foundation 9 (e.g., floor) in a working site. A workpiece 8 (a measurement target) is fixed on the foundation 9. The profile measuring machine 1 includes a probe 7 configured to detect the workpiece 8. The probe 7 is supported by a three-dimensional movement mechanism 10 straddling the workpiece 8.

In the exemplary embodiment, in order to measure a large-size workpiece 8, an existing table with a stone-made surface plate is omitted and the workpiece 8 is directly fixed on the foundation 9.

The three-dimensional movement mechanism 10 includes a first column 11, a second column 12 and a crossbar 13, thereby forming a portal structure. A spindle 15 is provided to the crossbar 13 via a saddle 14. The probe 7 is attached to a lower end of the spindle 15. The saddle 14 is movable along the crossbar 13 by a Y-axis movement mechanism 16. The spindle 15 is movable upward and downward in a Z-axis direction with respect to the saddle 14 by a Z-axis movement mechanism 17.

The first column 11 is independently supported by a first guide 21. The second column 12 is independently supported by a second guide 22.

The first guide 21, which is shaped in a rectangular box made of steel (first material), is fixed on the foundation 9 via a plurality of first supports 31.

The second guide 22, which is shaped in a rectangular solid made of stone (second material), is fixed on the foundation 9 via a plurality of second supports 32.

The first guide 21 and the second guide 22 are provided side-by-side with a region of the foundation 9, where the workpiece 8 is fixed, interposed between the first guide 21 and the second guide 22 and extend in an X-axis direction in parallel to each other.

The first supports 31 and the second supports 32 are each shaped in a steel-made rectangular box.

An X-axis movement mechanism 18 is set to the first guide 21, whereby the first column 11 is movable in the X-axis direction.

The second guide 22 has a smooth upper surface 221. An air pad 121 provided at a lower end of the second column 12 is slidably in contact with the upper surface 221.

Accordingly, when the X-axis movement mechanism 18 moves the first column 11 in the X-axis direction, an entire portal structure including the crossbar 13 and the second column 12 is movable in the X-axis direction.

The profile measuring machine 1 includes a controller 90 (calculator). The controller 90 is configured to control the movement of the probe 7 using the aforementioned X-axis movement mechanism 18, Y-axis movement mechanism 16 and Z-axis movement mechanism 17 and collectively conduct both a processing of a detection signal from the probe 7 and a calculation of a measurement value of the workpiece 8.

A height adjustment mechanism 41 shaped in a plate is provided to an upper surface, which is in contact with the first guide 21, of each of the first supports 31. A height adjustment mechanism 42 shaped in a plate is provided to an upper surface, which is in contact with the second guide 22, of each of the second supports 32.

The height adjustment mechanisms 41 and 42 are each in a form of a laminate of piezoelectric elements. In response to externally applied voltage, a thickness of each of the height adjustment mechanisms 41 and 42 is fluctuated, whereby the first guide 21 and the second guide 22 are independently adjustable in height with respect to the foundation 9.

The first guide 21 and the second guide 22 are respectively attached with temperature sensors 43 and 44 configured to detect the respective temperatures of the first guide 21 and the second guide 22.

The height adjustment mechanisms 41, 42 and the temperature sensors 43, 44 are connected to the controller 90.

According to a preset compensation program, the controller 90 is configured to calculate a thermal expansion amount of the first guide 21 at a temperature represented by a temperature signal from the temperature sensor 43 while calculating a thermal expansion amount of the second guide 22 at a temperature represented by a temperature signal from the temperature sensor 44, and control the height adjustment mechanisms 41, 42 to cancel a difference between the thermal expansion amounts.

When the temperatures exceed a reference temperature (e.g., 20 degrees C.), since the steel-made first guide 21 has a large thermal expansion rate whereas the stone-made second guide 22 has a small thermal expansion rate, the first column 11 supported by the first guide 21 is raised higher than the second column 12 supported by the second guide 22. In response, the controller 90 controls the height adjustment mechanism 42 of each of the second supports 32 to increase the thickness to raise the second guide 22, thereby adjusting the height of the second column 12 to be the same as the height of the first column 11.

When the temperature falls below the reference temperature (e.g., 20 degrees C.), the first column 11 supported by the first guide 21 is positioned lower than the second column 12 supported by the second guide 22. In response, the controller 90 controls the height adjustment mechanism 41 of each of the first supports 31 to increase the thickness to raise the first guide 21, thereby adjusting the height of the first column 11 to be the same as the height of the second column 12.

In this adjustment, instead of operating only one of the height adjustment mechanisms 41 and 42, the other of the height adjustment mechanisms 41 and 42 also may be operated in a reverse direction. For instance, while the height adjustment mechanism 41 is raised, the height adjustment mechanism 42 may be lowered.

The controller 90, the height adjustment mechanisms 41, 42 and the temperature sensors 43, 44 define a thermal expansion compensator 40.

According to the first exemplary embodiment, the following advantageous effects are obtained.

According to the exemplary embodiment, when an air temperature or an operation state differentiates the first guide 21 and the second guide 22 in the generated thermal expansion, the expansion compensation portion 40 can compensate the difference in the thermal expansion using the height adjustment mechanisms 41, 42 to adjust the respective heights of the first column 11 and the second column 12 to be the same.

The presence of the above-described thermal expansion compensator 40 allows the first material for the first guide 21 and the second material for the second guide 22 to be a combination of different materials such as stone and metal.

As a result, since one of the materials for the first guide 21 and the second guide 22 is not stone, even when the profile measuring machine 1 is enlarged, an increase in costs and a manufacturing period can be restrained. Moreover, since rust and a scratch are not generated on the upper surface 221 of the stone-made second guide 22 to avoid the smoothness of the upper surface 221 from being deteriorated, the upper surface 221 can stably function as the guide for the air pad 121 of the second column 12.

Although the temperature sensors 43, 44 are respectively provided to the first guide 21 and the second guide 22 in the exemplary embodiment, only one of the temperature sensors 43, 44 may be provided to the corresponding one of the first guide 21 and the second guide 22 for simplification. The temperature sensors 43, 44 are provided to the respective first guide 21 and second guide 22 in one-to-one correspondence, however, a plurality of temperature sensors 43 may be provided to the first guide 21 and a plurality of temperature sensors 44 may be provided to the second guide 22. Moreover, the temperature sensors 43, 44 may detect an air temperature in addition to the respective temperatures of the first guide 21 and second guide 22. Alternatively, the temperature sensors 43, 44 may be attached to the portal structure to detect a temperature thereof.

The height adjustment mechanisms 41, 42 are not necessarily provided to both of the first guide 21 and the second guide 22. One of the height adjustment mechanisms 41, 42 may be provided to the corresponding one of the first guide 21 and the second guide 22. When one of the height adjustment mechanisms 41, 42 is provided to the corresponding one of the first guide 21 and the second guide 22, it is desirable to apply a predetermined bias voltage in advance to allow the one of the height adjustment mechanisms 41, 42 to solely raise and lower the corresponding one of the first guide 21 and the second guide 22.

### Second Exemplary Embodiment

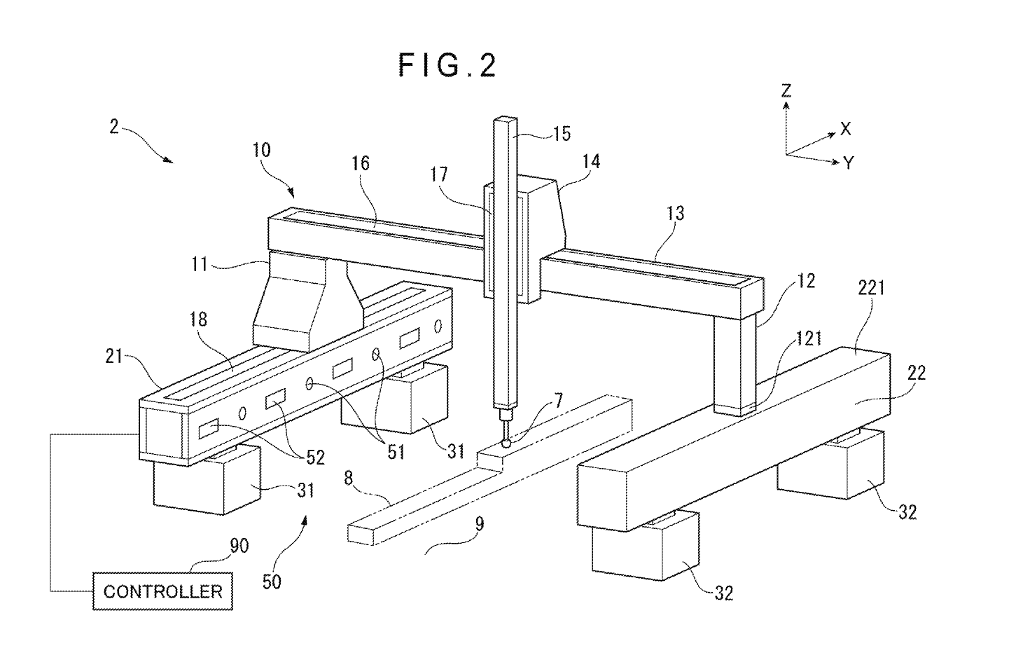

FIG. 2 shows a profile measuring machine 2 according to a second exemplary embodiment of the invention.

The profile measuring machine 2 has the same basic structure as the profile measuring machine 1 according to the first exemplary embodiment. Accordingly, the overlapping description of the common parts will be omitted and different parts will be described below.

In the second exemplary embodiment, the height adjustment mechanisms 41, 42 of the first exemplary embodiment are not provided.

A plurality of temperature sensors 51 are attached to a lateral surface of the first guide 21. A plurality of temperature adjusting devices 52 (i.e., a temperature adjuster) are attached to the lateral surface of the first guide 21 such that the temperature adjusting devices 52 are alternated with the temperature sensors 51.

A device (e.g., Peltier device) heatable and coolable by an external electric force is usable as the temperature adjusting devices 52. Alternatively, each of the temperature adjusting devices 52 may be in a combination of an electric heating wire and a water cooler.

The plurality of temperature sensors 51 and the plurality of temperature adjusting devices 52 are connected to the controller 90.

According to a preset compensation program, the controller 90 is configured to control the temperature adjusting devices 52 to keep the first guide 21 at a constant temperature, based on a temperature of the first guide 21 represented by temperature signals from the temperature sensors 51.

Even when a change in the air temperature or a heat generated during the operation changes the temperature of the first guide 21 to thermally expand the first guide 21, the control operation of the controller 90 can keep the constant temperature of the first column 11 and prevent the first column 11 from being thermally expanded, so that the first column 11 and the second column 12 are controllable to be constantly at the same height.

The controller 90, the plurality of temperature sensors 51 and the plurality of temperature adjusting devices 52 define a thermal expansion compensator 50.

Also in the second exemplary embodiment, since the thermal expansion compensator 50 keeps the constant temperature of the first guide 21, the first column 11 and the second column 12 can be kept at the same height.

Accordingly, also in the second exemplary embodiment, the first material for the first guide 21 and the second material for the second guide 22 can be a combination of different materials such as stone and metal.

Consequently, even when the profile measuring machine 2 is enlarged, an increase in costs and a manufacturing period can be restrained. Moreover, since rust and a scratch are not generated on the upper surface 221 to avoid the smoothness of the upper surface 221 from being deteriorated, the upper surface 221 can stably function as the guide for the air pad 121 of the second column 12.

Although the plurality of temperature sensors 51 and the plurality of temperature adjusting devices 52 are provided to the first guide 21 in the second exemplary embodiment, the plurality of temperature sensors 51 and the plurality of temperature adjusting devices 52 may be provided to the second guide 22 or both of the first guide 21 and the second guide 22.

In the second exemplary embodiment, the first guide 21 is made of steel and is likely to be thermally expanded, whereas the second guide 22 is made of stone and is unlikely to be thermally expanded. Accordingly, it is more effective to provide the thermal expansion compensator 50 of the second exemplary embodiment to the first guide 21 that is more greatly thermally-expanded than the second guide 22.

### Third Exemplary Embodiment

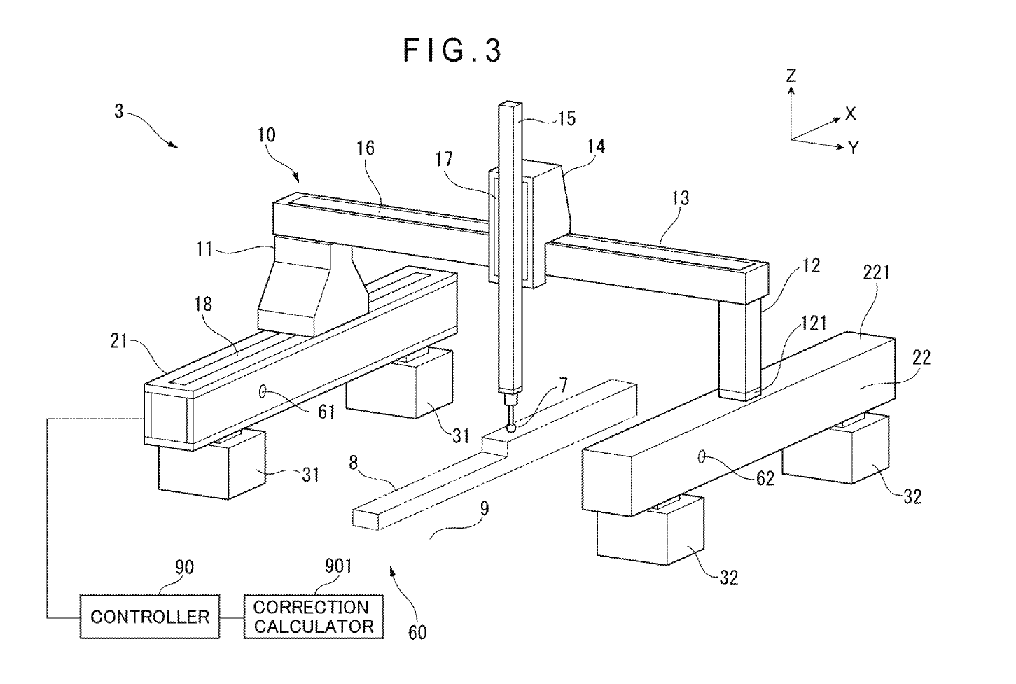

FIG. 3 shows a profile measuring machine 3 according to a third exemplary embodiment of the invention.

The profile measuring machine 3 has the same basic structure as the profile measuring machine 1 according to the first exemplary embodiment. Accordingly, the overlapping description of the common parts will be omitted and different parts will be described below.

In the third exemplary embodiment, the height adjustment mechanisms 41, 42 of the first exemplary embodiment are not provided.

Temperature sensors 61 and 62 are respectively attached to the lateral surfaces of the first guide 21 and the second guide 22.

The controller 90, to which the temperature sensors 61, 62 are connected, includes a correction calculator 901 (measurement value corrector) configured to correct a measurement value obtained by the probe 7 based on temperatures detected by the temperature sensors 61, 62.

In accordance with a preset correction calculation program, the correction calculator 901 calculates a height displacement of the probe 7 caused by a difference in thermal expansion between the first guide 21 and the second guide 22, based on the temperatures of the first guide 21 and the second guide 22 represented by temperature signals from the temperature sensors 61, 62. Subsequently, the correction calculator 901 corrects height data among positional data of the probe 7 acquired by the controller 90 by the height displacement of the probe 7 caused by the difference in thermal expansion between the first guide 21 and the second guide 22.

Even when a change in the air temperature or a heat generated during the operation changes the temperatures of the first guide 21 and the second guide 22 to displace the first guide 21 and the second guide 22 due to the difference in thermal expansion between the first guide 21 and the second guide 22, the correction calculator 901 can correct the position data of the probe 7 by the height displacement.

The temperature sensors 61, 62 and the correction calculator 901 define a thermal expansion corrector 60.

In the third exemplary embodiment, even when the temperatures of the first guide 21 and the second guide 22 are changed to displace the first guide 21 and the second guide 22 due to the difference in thermal expansion between the first guide 21 and the second guide 22, the thermal expansion corrector 60 can correct the position data of the probe 7 by the height displacement.

Accordingly, also in the third exemplary embodiment, the first material for the first guide 21 and the second material for the second guide 22 can be a combination of different materials such as stone and metal.

Consequently, even when the profile measuring machine 3 is enlarged, an increase in costs and a manufacturing period can be restrained. Moreover, since rust and a scratch are not generated on the upper surface 221 to avoid the smoothness of the upper surface 221 from being deteriorated, the upper surface 221 can stably function as the guide for the air pad 121 of the second column 12.

### Other Embodiment(s)

It should be appreciated that the scope of the invention is not limited to the above exemplary embodiments but modifications and improvements that are compatible with an object of the invention are included within the scope of the invention.

In the above exemplary embodiments, in order to measure a large-size workpiece 8, an existing table with a stone-made surface plate is not provided and the workpiece 8 is directly fixed on the foundation 9.

However, a table may be interposed between the first guide 21 and the second guide 22 and the workpiece 8 may be fixed on the table.

The added table may be continuous to one of the first guide 21 and the second guide 22.

However, when the second guide 22 is made of stone as described in the above exemplary embodiments and the table continuous to the second guide 22 is also made of stone, a stone-made portion accounts for a greater part of the machine, which is unsuitable for solving an increase in costs and a manufacturing period and a difficulty in transportation. When the table is continuous to the steel-made first guide 21, the stone-made portion is limited to the minimum (e.g., limited to the second guide 22), which can solve the increase in the costs and the manufacturing period and the difficulty in transportation.

In the above exemplary embodiments, the first material for the first guide 21 is steel and the second material for the second guide 22 is stone. However, the respective materials for the first guide 21 and the second guide 22 are not limited to steel and stone.

The first material is not limited to steel but may be other metal materials. As long as having a predetermined rigidity, the first material may be, for instance, a synthetic resin material reinforced by fibers.

The second material is not limited to stone but may be other minerals, glass, ceramics and the like. The second material preferably has a small thermal deformation with a high processing accuracy.

What is claimed is:

1. A profile measuring machine comprising:
a first column and a second column forming a portal structure of a movement mechanism supporting a probe;
a first guide made of a first material and configured to guide the first column;
a second guide provided in parallel to the first guide, made of a second material different from the first material, and configured to guide the second column;
a first support supporting the first guide;
a second support supporting the second guide; and
a thermal expansion compensator provided to at least one of the first guide, the second guide, the first support or the second support, and configured to compensate a difference in thermal expansion between the first guide and the second guide.

2. The profile measuring machine according to claim 1, further comprising:
at least one temperature sensor configured to detect a temperature of at least one of the first guide or the second guide, wherein
the thermal expansion compensator is configured to compensate the difference in thermal expansion between the first guide and the second guide with reference to the temperature detected by the at least one temperature sensor.

3. The profile measuring machine according to claim 1, wherein
the thermal expansion compensator comprises at least one height adjustment mechanism provided to at least one of the first support or the second support.

4. The profile measuring machine according to claim 1, wherein
the thermal expansion compensator comprises a temperature adjuster configured to heat and/or cool the first guide and the second guide.

5. A profile measuring machine comprising:
a movement mechanism having a portal structure formed by a first column and a second column;
a probe supported by the movement mechanism;
a first guide made of a first material and configured to guide the first column;
a second guide provided in parallel to the first guide, made of a second material different from the first material, and configured to guide the second column; and
a calculator configured to control the movement mechanism and calculate a measurement value based on a signal from the probe,
the calculator comprising a measurement value corrector configured to correct the measurement value based on a difference in thermal expansion between the first guide and the second guide.

6. The profile measuring machine according to claim 5, further comprising:
at least one temperature sensor configured to detect a temperature of at least one of the first guide or the second guide, wherein
the measurement value corrector is configured to correct the measurement value with reference to the temperature detected by the at least one temperature sensor.

7. The profile measuring machine according to claim 1, wherein
the first material is stone and the second material is metal.

8. The profile measuring machine according to claim 5, wherein
the first material is stone and the second material is metal.
